(19) United States
(12) Patent Application Publication
(10) Pub. No.: US 2023/0294049 A1
(43) Pub. Date: Sep. 21, 2023

(54) SYSTEMS AND METHODS FOR CARBONATING A LIQUID AT AMBIENT TEMPERATURE

(71) Applicant: PepsiCo, Inc., Purchase, NY (US)

(72) Inventors: John EATON, Yonkers, NY (US); Mary Katherine MITCHELL, Ossining, NY (US); Stephen BROWN, Essex (GB); Ross Peter JONES, Cambridge (GB); Charles Frazer KILBY, Cambridgeshire (GB); Laura Saranne KIMPTON, Hertfordshire (GB); Andrew Robert POTTER, Cambridgeshire (GB)

(21) Appl. No.: 18/183,807

(22) Filed: Mar. 14, 2023

Related U.S. Application Data
(60) Provisional application No. 63/269,358, filed on Mar. 15, 2022.

(51) Int. Cl. B01F 23/231; A23L 2/54; B01F 23/236; B01F 23/237

(52) U.S. Cl. CPC B01F 23/23121; A23L 2/54; B01F 23/2363; B01F 23/237621; B01F 2101/14

(57) ABSTRACT

Embodiments described herein relate to systems and methods for carbonating a liquid at ambient temperature. The system may include a liquid source; a carbon dioxide source; and a contactor for carbonating the liquid. The contactor may include channels and a sparge for carbonating liquid flowing through the channels. The system may produce a liquid having high levels of carbonation at ambient temperature. The sparge may generate microbubbles or nanobubbles to allow for cost-effective carbonation at ambient temperatures. The bubbles may have an average diameter of 100 μm or less. The system may carbonate liquid at a rate of 1 gram to 10 grams carbon dioxide per liter.

### CROSS-REFERENCE

This application claims the benefit of U.S. Provisional Application No. 63/269,358, filed Mar. 15, 2022, which is incorporated herein in its entirety by reference thereto.

### BACKGROUND

The present disclosure relates to systems and methods for carbonating a liquid. More specifically, the present disclosure relates to systems and methods for carbonating a liquid with microbubbles or nanobubbles of a gas (e.g., carbon dioxide) at ambient temperature.

### BRIEF SUMMARY

Some embodiments are directed to a system for carbonating a liquid. In some embodiments, the system includes a liquid source; a carbon dioxide source; and a contactor for carbonating the liquid. In some embodiments, the contactor includes a first channel, a second channel, and a sparge. In some embodiments, the first channel is in communication with the liquid source, and the first channel has a first inner diameter. In some embodiments, the first channel includes a first end, a second end, and a first inlet defined in a sidewall of the first channel. In some embodiments, the second channel includes a first end in fluid communication with the second end of the first channel, and the second channel has a second inner diameter that is smaller than the first inner diameter. In some embodiments, the sparge is disposed at least partially within the first channel and at least partially within the second channel and is configured to generate bubbles having an average diameter of 100 μm or less. In some embodiments, the sparge is configured to provide at 1 gram to 10 grams carbon dioxide per liter of the liquid flowing through the contactor. In some embodiments, the sparge is configured to provide from 1 gram carbon dioxide per liter of the liquid to 10 grams carbon dioxide per liter of the liquid. In some embodiments, the system is configured to operate at ambient temperatures.

In some embodiments, the system further includes a restrictor disposed at the second end of the first channel, and the restrictor includes a tapered inner surface.

In some embodiments, the sparge includes pores through which carbon dioxide flows. In some embodiments, the pores are disposed only on the portion of the sparge disposed in the second channel.

In some embodiments, the sparge includes a sealing end configured to seal the first end of the first channel; a first portion of the sparge that is coaxial with the first channel; a second portion of the sparge that is coaxial with the second channel; and a tapered end disposed in the second channel.

In some embodiments, the system is configured to carbonate the liquid with 3 grams to 8 grams carbon dioxide per liter of liquid.

In some embodiments, ambient temperature is from about 4° C. to about 32° C.

In some embodiments, the system is configured to carbonate 1 liter to 10 liters of the liquid per minute.

In some embodiments, the system is configured to carbonate 200 liters to 2000 liters per minute.

In some embodiments, the system is configured to carbonate the liquid without thermal treatment.

In some embodiments, the liquid is one of cola, carbonated soft drink, juice, coffee, tea, water, dairy, or a protein-based liquid.

In some embodiments, the sparge has an outer diameter that is less than the second inner diameter such that a sparge gap is formed between the sparge and the second channel.

In some embodiments, the system has a height of about 2 meters, a length of about 1 meter, and a width of about 1 meter.

Some embodiments are directed to a method of carbonating a liquid. In some embodiments, the method includes: flowing the liquid through a first channel of a contactor at a rate of at least 1 liter to 2000 liters per minute; and injecting, by a sparge, carbon dioxide bubbles into the liquid. In some embodiments, the carbon dioxide bubbles have an average diameter of 100 μm or less. In some embodiments, the carbon dioxide bubbles are injected at a rate of 1 gram to 10 grams carbon dioxide per liter of the liquid. In some embodiments, the method includes carbonating the liquid without thermal treatment.

In some embodiments, the method further includes flowing the liquid through a second channel of the contactor.

In some embodiments, the first channel has a first inner diameter and the second channel has a second inner diameter that is smaller than the first inner diameter.

In some embodiments, the sparge is disposed at least partially in the first channel and at least partially in the second channel.

In some embodiments, the rate is 500 liters per minute to 2000 liters per minute.

In some embodiments, the carbon dioxide is injected at a rate of 5 grams to 10 grams carbon dioxide per liter of the liquid.

In some embodiments, the liquid has a temperature of about 4° C. to about 32° C.

Some embodiments are directed to a system for carbonating a liquid. In some embodiments, the system includes a contactor for carbonating the liquid flowing through the contactor. In some embodiments, the contactor includes a first channel having a first inner diameter; a second channel in fluid communication with the first channel, the second channel having a second inner diameter; and a sparge disposed at least partially within the first channel and at least partially within the second channel. In some embodiments, the sparge configured to deliver bubbles of carbon dioxide to the liquid at a rate of at least 5 grams carbon dioxide per liter of the liquid flowing through the carbonator. In some embodiments, the bubbles have an average diameter of 100 μm or less. In some embodiments, the system is configured to operate at ambient temperature.

In some embodiments, the second inner diameter is smaller than the first inner diameter.

In some embodiments, the system is configured to carbonate 1 liter to 2000 liters of the liquid per minute.

In some embodiments, the sparge has an outer diameter that is less than the second inner diameter such that a sparge gap is formed between the sparge and the second channel, and wherein the sparge gap is 0.75 mm to 10 mm.

In some embodiments, the sparge is coaxial with the first channel and coaxial with the second channel.

In some embodiments, the sparge includes a sealing end configured to seal a first end of the first channel.

In some embodiments, the sparge is a sintered sparge.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 illustrates a carbonator according to some embodiments.

FIG. 2 illustrates a flow chart for a system for preparing carbonated beverages according to some embodiments.

FIG. 3A illustrates a flow chart for a carbonator according to some embodiments.

FIG. 3B illustrates a flow chart for a carbonator according to some embodiments.

FIG. 4 illustrates a contactor according to some embodiments for use with a carbonator.

FIG. 5 illustrates water flow through a contactor according to some embodiments.

FIG. 6 illustrates a method of preparing a carbonated liquid according to some embodiments.

FIG. 7 illustrates a method of preparing a carbonated liquid according to some embodiments.

### DETAILED DESCRIPTION

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Carbonated beverages are often created by injecting carbon dioxide into a liquid. These carbonation methods typically use thermal treatments (e.g., cooling) during carbonation. For example, because carbonation processes are enhanced at lower temperatures, existing methods require chilling a liquid pre- or post-carbonation. Otherwise, there is a limit to the about of carbonation possible if not chilled. This is because lower temperatures enable carbonation (i.e., the dissolution of carbon dioxide into a liquid) by ensuring the proper solubility needed for the product at required speeds. If the temperatures are too high, existing processes do not allow for higher carbonation levels to be practical or economical. Although the chilled carbonated liquid may be filled in a container, the liquid must be warmed to room temperature prior to subsequent processing (e.g., labeling, packing, storing, shipping etc.).

The chilling and warming requires significant capital outlay for equipment and real estate, such as, for example, cooling equipment (e.g., chillers) and warming equipment (e.g., tunnel warmers). This equipment may use a significant amount of space, utilities, and water, and existing systems require significant operating costs. For existing methods carbonating liquid at a rate of 600 L/min, every 1° C. of temperature change requires approximately a 42 kW energy input. For example, chilling from 15° C. to 5° C., then warming back to 15° C. requires approximately 840 kW energy input. Further, existing systems that do not use chilling before carbonation have limited compatibility with standard beverage-making machines, cannot be retrofitted into existing systems, and are not compatible with highly-carbonated liquids (e.g., carbonated soft drinks such as colas and seltzers).

Additionally, existing methods are not able to achieve high dissolution rates without adding excess carbon dioxide to the liquid. This results in significant amounts of wasted carbon dioxide during the carbonation process, and can result in inconsistent product quality.

Embodiments described herein overcome these and other challenges by providing—among other benefits—systems and methods for non-thermal carbonation of liquids. Moreover, embodiments described herein use smaller bubble sizes to increase dissolution rate and enable room temperature carbonation. For example, bubbles may be microbubbles or nanobubbles. Embodiments described herein allow for non-thermal carbonation of liquid without adversely affecting the attributes of the resulting carbonated beverage (e.g., taste, color, shelf life, etc.). Moreover, embodiments described herein can be used in various applications, including in manufacturing lines for production-scale operations to single-serve operations (e.g., make-my-own systems and fountain dispensers). Embodiments described herein can also improve the consistency of the end product and reduce wasted carbon dioxide by allowing a complete dissolution approach to carbonation. In embodiments, a carbonation system 30 may include a contactor 200 configured to provide non-thermal carbonation of liquids using smaller bubble sizes.

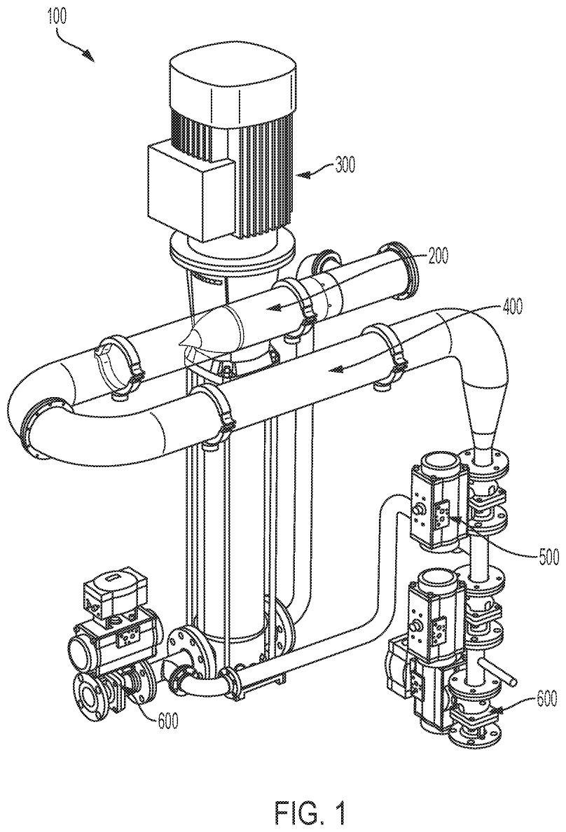

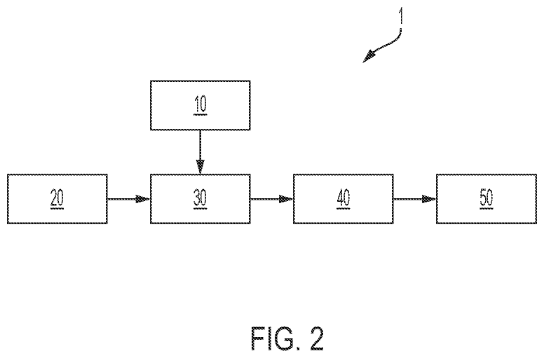

FIG. 1 illustrates a carbonator according to some embodiments. For example, carbonator 100 may include contactor 200, pump 300, dissolution pipe 400, restrictor valve 500, and isolation valve 600. Carbonator 100 may be sized to enable retrofitting in a production-scale system (e.g., system 1 shown in FIG. 2). For example, carbonator 100 may have a width of about 1 meter, a length of about 1 meter, and a height of about 2 meters. The size of carbonator 100 allows for retrofitting existing systems with carbonators disclosed herein (e.g., carbonator 100). In some embodiments, carbonator 100 is a retrofit carbonator for replacing an existing carbonation system.

FIG. 2 illustrates a flow chart for a system of making a bottling or canning a carbonated beverage. For example, system 1 may include gas source 10, liquid source 20, carbonation system 30, filling system 40, and packaging system 50. In some embodiments, gas source 10 is a source of carbon dioxide, nitrous oxide, nitrogen, or a mixture thereof. In some embodiments, liquid source 20 is a source of a beverage liquid. In some embodiments, liquid source 20 includes one or more of water, juice, dairy, sweeteners, and flavoring. In some embodiments, liquid source 20 includes water. In some embodiments, liquid source 20 includes water, sweeteners, and flavoring. In some embodiments, liquid source 20 includes a cola. In some embodiments, carbonation system 30 includes equipment for carbonating the liquid from liquid source 20. In some embodiments, carbonation system 30 includes a carbonator (e.g., carbonator 100) that produces a carbonated liquid. In some embodiments, filling system 40 includes equipment for filling containers (e.g., bottles or cans) with the carbonated liquid. In some embodiments, packaging system 50 includes equipment for capping and labeling the containers prior to distribution. In some embodiments, carbonator 100 is used in a make-my-own system, and filling system 40 fills at-home bottles, glasses, or cups. In some embodiments, carbonator 100 is used in fountain dispensers, and filling system 40 fills a cup at the point of sale.

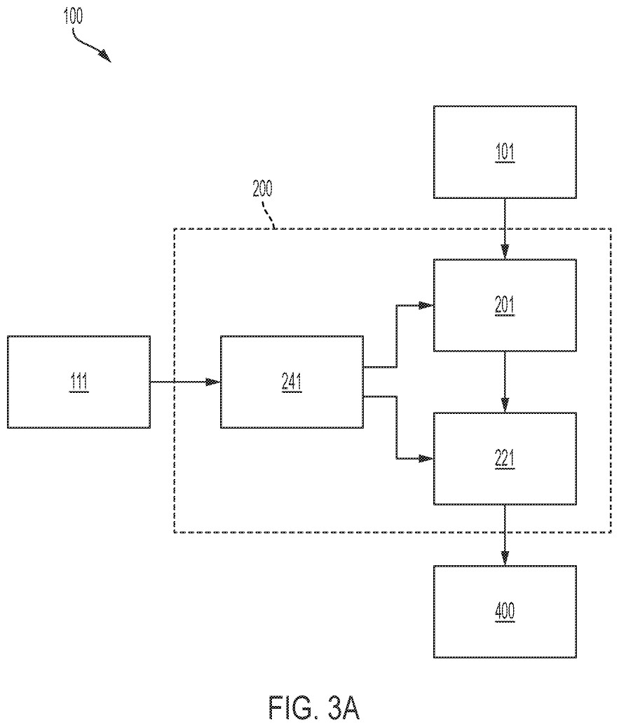

FIG. 3A illustrates a flow chart for a carbonator 100 according to some embodiments. Carbonator 100 may include liquid inlet 101, gas inlet 111, contactor 200, and dissolution pipe 400. In some embodiments, contactor includes first channel 201, second channel 221, and sparge 241. In some embodiments, gas (e.g., carbon dioxide) flows from gas source 10 to gas inlet 111. In some embodiments, liquid (e.g., water) flows from liquid source 20 to liquid inlet 101. As shown in FIG. 3A, liquid may flow through liquid inlet 101 to first channel 201, from first channel 201 to second channel 221, and from second channel 221 to dissolution pipe 400. In some embodiments, liquid flows at a flow rate of about 0.02 L/min to about 2000 L/min (e.g., about 0.2 L/min to about 6 L/min, about 1.5 L/min to about 6 L/min, about 3.5 L/min to about 75 L/min, about 7.5 L/min to about 20 L/min, about 3 L/min to about 15 L/min, or about 150 L/min to about 1000 L/min). In some embodiments, carbonator 100 is used in a make-my-own beverage system, and the liquid flows at a flow rate of about 0.2 L/min to about 6 L/min (e.g., 1.5 L/min to about 6 L/min). In some embodiments, carbonator 100 is used in a production-scale system, and the liquid flows at a flow rate of about 150 L/min to about 1000 L/min. In some embodiments, the liquid flows at a rate of about 400 L/min to about 600 L/min (e.g., about 450 L/min to about 500 L/min). In some embodiments, the liquid flows at a rate of about 475 L/min. In some embodiments, the liquid flows at a rate of about 1000 L/min to about 1500 L/min (e.g., about 1100 L/min to about 1300 L/min or about 1150 L/min to about 1200 L/min). In some embodiments, the liquid flows at a rate of about 1180 L/min.

As shown in FIG. 3A, gas may flow through gas inlet 111 to sparge 241, and from sparge 241 to first channel 201 or second channel 221, and from first channel 201 or second channel 221 to dissolution pipe 400. In some embodiments, gas flows from sparge 241 to both first channel 201 and second channel 221. In some embodiments, gas flows from sparge 241 to only one of first channel 201 or second channel 221. In some embodiments, gas flows from sparge 241 to second channel 221 only. As gas flows from sparge to first channel 201 or second channel 221, the gas mixes with the liquid flowing through first channel 201 or second channel 221 to form a liquid/gas mixture. The liquid/gas mixture then flows from second channel 221 to dissolution pipe 400, where the gas dissolves in the liquid.

FIG. 3B illustrates a flow chart for a carbonator 100 having more than one contactor 200. In some embodiments, carbonator 100 can have 1 or more (e.g., 2 or more, or 3 or more) contactors 200. In some embodiments, carbonator 100 can have multiple carbonators operated in parallel. In some embodiments, carbonator 100 can have multiple carbonators operated in series.

For example, carbonator 100 may include liquid inlet 101, gas inlet 111, first contactor 200a, second contactor 200b, and dissolution pipe 400. In some embodiments, as shown in FIG. 3B, carbonator 100 includes two contactors (e.g., first contactor 200a and second contactor 200b) operating in parallel. In some embodiments, first contactor 200a and second contactor 200b are the same contactor. In some embodiments, first carbonator 200a and second carbonator 200b are different contactor.

In some embodiments, carbonator 100 can include two contactors (e.g., contactors 200a and 200b) that can operate simultaneously. In some embodiments, one of the two contactor 200a and 200b can be turned off to adjust the flow rate through carbonator 100. For example, in some embodiments, contactor 200a can operate while contactor 200b is turned off. In some embodiments, each contactor 200a and 200b includes a valve configured to permit or prevent flow through the contactor 200a and 200b. This can allow for easy adjustments of flow rate. In some embodiments, each contactor (e.g., contactors 200a and 200b) operate at the same flow rates or different flow rates. For example, in some embodiments, liquid can flow through contactor 200a at a first rate and through contactor 200b at a second rate. In some embodiments, the first rate is equal to the second rate. In some embodiments, the first rate is different than the second rate. In some embodiments, gas (e.g., carbon dioxide) can flow through each contactor at the same rate or at different rate. For example, in some embodiments, liquid can flow through contactor 200a at a first rate and through contactor 200b at a second rate. In some embodiments, the first rate is equal to the second rate. In some embodiments, the first rate is different than the second rate. In some embodiments, gas can flow through only one of contactor 200a or 200b.

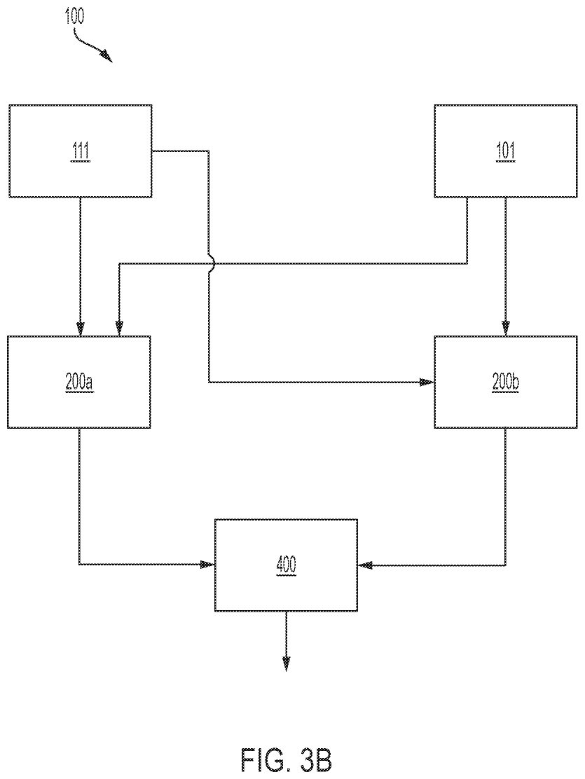

FIG. 4 illustrates a contactor used in a carbonator according to some embodiments. Contactor 200 may include first channel 201, second channel 221, sparge 241, and restrictor 261. In some embodiments, first channel 201 includes first end 203, second end 205, liquid inlet channel 207, and liquid inlet opening 209. In some embodiments, second channel 221 includes first end 223, second end 225, and outlet 227. In some embodiments, sparge 241 includes sealing end 243, sparge end 245, gas inlet 247, and gas channel 249.

In some embodiments, second end 205 of first channel 201 and first end 223 of second channel 221 are coupled together such that first channel 201 and second channel 221 are in fluid communication. In some embodiments, first channel 201 is in fluid communication with liquid inlet channel 207. In some embodiments, liquid flows through liquid opening 209 through liquid inlet channel 207 to first channel 201.

In some embodiments, first channel 201 and second channel 221 each have an inner diameter. In some embodiments, first channel 201 has an inner diameter of about 15 mm to about 40 mm (e.g., about 20 mm to about 35 mm or about 25 mm to about 30 mm). In some embodiments, first channel 201 has an inner diameter of about 20 mm.

In some embodiments, second channel 221 has an inner diameter of about 10 mm to about 25 mm (e.g., about 11 mm to about 20 mm or about 12 mm to about 16 mm). In some embodiments, second channel 221 has an inner diameter of about 14 mm. In some embodiments, the inner diameter of first channel 201 is larger than the inner diameter of second channel 221. In some embodiments, the inner diameter of first channel 201 is the same as the inner diameter of second channel 221

Contactor 200 may include sparge 241. As shown in FIG. 4, sparge 241 may be at least partially disposed in and coaxial with first channel 201 and second channel 221. In some embodiments, sparge 241 is disposed at least partially within first channel 201. In some embodiments, sparge 241 is disposed at least partially within second channel 221. In some embodiments, sparge 241 is disposed at least partially within both first channel 201 and second channel 221. In some embodiments, sparge 241 is coaxial with first channel 201. In some embodiments, sparge 241 is coaxial with second channel 221. In some embodiments, sparge 241 is coaxial with both first channel 201 and second channel 221.

Various factors may affect the performance of contactor 200. These factors include, among others, sparge gap, pressure within the contactor, and velocity of fluid (i.e., gas and liquid) flowing through the contactor. Each of these is discussed in detail below.

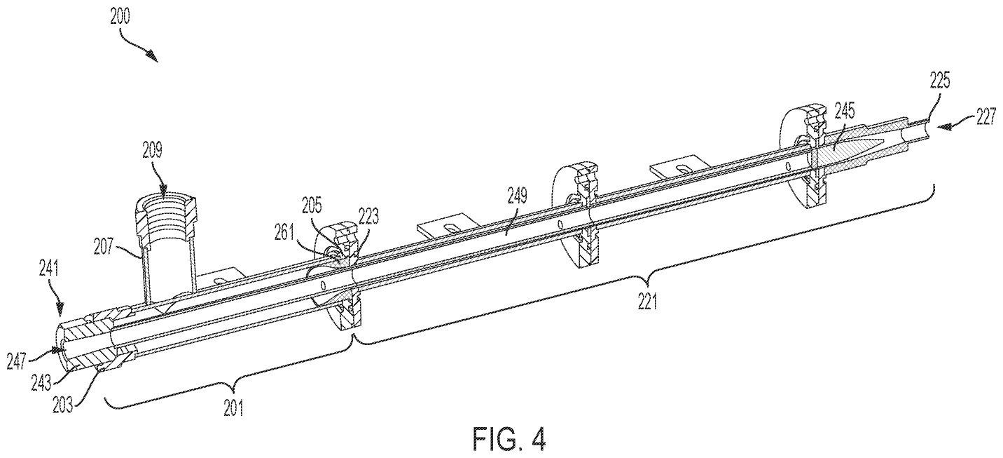

As illustrated in FIG. 5, sparge 241 may be positioned within first channel 201 and/or second channel 221 to form sparge gap 229 between surface 251 of sparge 241 and wall of the contactor (e.g., wall 222 of second channel 221). In some embodiments, as illustrated in FIG. 5, sparge gap 229 may be formed by the annular space between sparge 241 and outer wall of the contactor. The size of sparge gap 229 may affect performance of carbonator 100. For example, if sparge gap 229 is too small, the pump required to move fluid through the gap may be excessively large. Moreover, if sparge gap 229 is too small, it may be impractical to manufacture or clean. And if sparge gap 229 is too large, the liquid flow rate will drop too low. In some embodiments, the size of sparge gap 229 is distance 231. In some embodiments, distance 231 is 0.5 mm to about 15 mm (e.g., about 0.75 mm to about 10 mm, about 0.75 to 4 mm, about 2 mm to about 4 mm, or about 6 mm to about 8 mm). In some embodiments, distance 231 is about 2 mm to about 4 mm. In some embodiments, distance 231 is about 0.75 mm. In some embodiments, distance 231 is about 1 mm. In some embodiments, distance 231 is about 4 mm.

Sparge 241 may consist of pores disposed on at least part of sparge 241 through which gas flows. Sparge 241 may have a pore size of about 0.1 μm to about 30 μm (e.g., about 0.2 μm to about 20 μm, about 0.5 μm to about 10 μm, or about 1 μm to about 3 μm). In some embodiments, sparge 241 has a pore size of about 2 μm.

In some embodiments, sealing end 243 of sparge 241 seals first end 203 of first channel 201. Sparge 241 may include gas inlet 247 at sealing end 243. In some embodiments, gas (e.g., carbon dioxide) flows into gas channel 249 through gas inlet 247. As gas flows into sparge 241, gas is bubbled out through the walls (e.g., surface 251) of sparge 241 and into liquid flowing through first channel 201 and/or second channel 221. Sparge 241 may have a length of about 75 mm to about 500 mm (e.g., about 75 mm to about 150 mm, about 150 mm to about 450 mm, about 200 mm to about 400 mm, or about 150 mm to about 300 mm). In some embodiments, sparge 241 has a length of about 75 mm. In some embodiments, sparge 241 has a length of about 150 mm. In some embodiments, sparge 241 has a length of about 300 mm. Sparge 241 may have a diameter of about 5 mm to about 300 mm. In some embodiments, sparge 241 has a diameter of about 5 mm to about 20 mm (e.g., about 10 mm to about 15 mm or about 12 mm to about 13 mm). In some embodiments, sparge 241 has a diameter of about 12.7 mm. In some embodiments, sparge 241 has a diameter of about 50 mm to about 300 mm (e.g., about 100 mm to about 200 mm). Sparge 241 may have a sparge area. As used herein, the sparge area is area through which gas can bubble from the sparge to the liquid. For example, the sparge area of sparge 241 shown in FIG. 4 may be calculated according to the following formula:

Sparge Area=2πrl

where r=radius of the sparge and l=length of the sparge. In some embodiments, the sparge area of sparge 241 is about 4000 mm² to about 15,000 mm² (e.g., about 5000 mm² to about 7000 mm² or about 11,000 mm² to about 13,000 mm²). In some embodiments, the sparge area is about 6000 mm². In some embodiments, the sparge area is about 12,000 mm².

FIG. 5 illustrates fluid flow through contactors according to some embodiments. FIG. 5 shows a portion of contactor 200, including wall 222, sparge gap 229, sparge 241, sparge surface 251, liquid 1000, and gas 1100. FIG. 5 illustrates the effect of fluid velocity on bubble size. For example, as illustrated by FIG. 5, a higher fluid velocity results in bubbles becoming detached from surface 251 of sparge 241 earlier, resulting in smaller bubble sizes. For example, arrow 1001 represents a first fluid velocity, arrow 1002 represents a second fluid velocity that is higher than the first fluid velocity, and arrows 1101 represent gas flow. As illustrated by FIG. 5, a higher fluid velocity (arrow 1002) results in a larger number of smaller bubbles compared to the lower fluid velocity (arrow 1001). Example 1 shows carbonation at various fluid velocities. In some embodiments, the fluid velocity in contactor 200 is about 0.5 m/s to about 12 m/s (e.g., about 0.6 m/s to about 10.5 m/s or about 0.5 m/s to about 5 m/s). In some embodiments, the fluid velocity is at least 1.5 m/s.

Sparge 241 may deliver carbon dioxide bubbles that are on the order of micrometers or nanometers. Smaller bubbles used in some embodiments disclosed herein results in carbonation that is fast enough at ambient temperatures to enable economic viability. For example, Table 1 below shows the number of bubbles and total surface area of the gas bubbles at different bubble diameter sizes for 1 microliter volume of gas.

TABLE 1

| Bubble diameter | | Number of bubbles | Total surface area (mm²) |
|---|---|---|---|
| 1.24 | mm (1240 μm) | 1 | 4.8 |
| 0.5 | mm (500 μm) | 15 | 12 |
| 0.1 | mm (100 μm) | 1910 | 60 |
| 0.05 | mm (50 μm) | 15,279 | 120 |
| 0.01 | mm (10 μm) | 1,909,859 | 600 |

As shown in Table 1, 1 μL of gas having a bubble diameter of 10 μm has a total surface area 125 times greater than 1 μL of gas having a bubble diameter of 1.24 mm. And it has been discovered that such increases in the gas/liquid contact area under higher pressures compensates for increased temperatures, making ambient carbonation economically feasible. Accordingly, gas with a bubble diameter of 10 μm should dissolve 125 times faster than a gas with a bubble diameter of 1.24 mm. In some embodiments, sparge 241 produces bubbles of gas having an average diameter of about 0.001 μm to about 100 μm (e.g., about 0.01 μm to about 75 μm, about 0.1 μm to about 50 μm, about 1 μm to about 25 μm, or about 30 μm to about 50 μm). In some embodiments, sparge 241 produces bubbles of gas having an average diameter of about 50 μm or less (e.g., about 25 μm or less or about 10 μm or less). In some embodiments, sparge 241 produces bubbles having an average diameter of about 10 μm to about 50 μm.

Contactor 200 may include restrictor 261 disposed at second end 205 of first channel 201. In some embodiments, restrictor 261 has a central opening through which fluid can flow from first channel 201 to second channel 221. In some embodiments, restrictor 261 includes a tapered inner surface, as shown in FIG. 4, to accommodate the difference in inner diameters between first channel 201 and second channel 221. In some embodiments, the central opening of restrictor 261 has a diameter at a first end that is equal to the inner diameter of first channel 201. In some embodiments, the central opening of restrictor 261 has a diameter at a second end that is equal to the inner diameter of second channel 221. In some embodiments, restrictor 261 allows for a transition from the larger size of first channel 201 to the smaller size of second channel 221. This helps to increase the velocity in contactor 200 while preventing recirculation as the flow path narrows.

Liquid may flow through first channel 201 and second channel 221 around sparge 241. As liquid flows through first channel 201 and second channel 221, gas is injected in the liquid from the sparge to create a liquid/gas mixture. In some embodiments, sparge 241 includes sparge end 245. In some embodiments, sparge end 245 is tapered, as shown in FIG. 4. In some embodiments, sparge end 245 has a blunt end. In some embodiments, sparge end 245 minimizes turbulence and recirculation zone formation in the liquid/gas mixture flowing around sparge 241 as the liquid/gas mixture passes the sparge and recombines in second channel 221. In some embodiments, after passing the sparge and recombining, the liquid/gas mixture flows through outlet 227. In some embodiments, the liquid/gas mixture flows through outlet 227 to dissolution pipe 400, as discussed in more detail below. As shown throughout the Examples, systems according to some embodiments were able to consistently achieve carbonation greater than 7 g/L (e.g., greater than 8 g/L) over a range of various factors.

Sparge 241 may deliver gas to a liquid at a predetermined rate. In some embodiments, sparge 241 delivers gas to a liquid at a rate of about 60 g/s to about 100 g/s (e.g., about 70 g/s to about 90 g/s, or about 80 g/s to about 85 g/s). In some embodiments, sparge 241 delivers gas to a liquid at a rate of about 84 g/s. In some embodiments, sparge 241 delivers gas to a liquid at a rate of about 1 mol/s to about 3 mol/s (e.g., about 1.5 mol/sec to about 2.5 mol/s or about 1.75 mol/s to about 2.25 mol/s). In some embodiments, sparge 241 delivers gas to a liquid at a rate of about 1.9 mol/s.

In some embodiments, sparge 241 is a sintered sparge. Sintered sparges typically are specified to work over particular areal gas flow rates. As used “areal gas flow rate” is the amount of gas emerging per unit time per unit sparge surface area. If the areal gas flow rate is too high, the bubbles will not effectively dissolve in the liquid because the bubbles will grow too larger before detaching or will coalesce before dissolving. If the areal gas flow rate is too low, only the lowest pressure drop pores will show gas flow, which can negatively affect performance. As shown in Example 2, systems according to some embodiments were able to consistently achieve carbonation greater than 7 g/L (e.g., greater than 8 g/L) regardless the areal gas flow rate.

Contactor 200 may be configured to operate at incoming gas pressures of at least 5 bar (e.g., at least 15 bar). In some embodiments, contactor 200 operates at incoming gas pressure of about 0.5 bar to about 30 bar (e.g., about 5 bar to about 20 bar, about 5 bar to about 15 bar, about 8 bar to about 10 bar, about 15 bar to about 20 bar, about 20 bar to about 24 bar). In some embodiments, contactor 200 operates at incoming gas pressure of about 20 bar. In some embodiments, contactor 200 operates at incoming gas pressure of about 24 bar. In some embodiments, contactor 200 operates at incoming gas pressure of about 28 bar. Example 3 illustrates carbonation at various incoming gas pressures. In some embodiments, carbonator 100 is used in a make-my-own beverage system, and the incoming gas pressure is about 4 bar to about 24 bar (e.g., about 5 bar to about 15 bar or about 8 bar to about 10 bar). In some embodiments, carbonator 100 is used in a production-scale system, and the incoming gas pressure is about 4 bar to about 30 bar. Example 4 illustrates the post-sparge gas pressure.

Carbonation in contactor may be accomplished at ambient temperature. For example, carbonating at ambient temperature can mean carbonating water at its incoming water temperature, without heating or cooling. Further, carbonating at ambient temperature can mean carbonating at the dew point of the environment where carbonation occurs. Carbonating at the dew point has a further advantage of preventing liquid from building up behind a label after the container has been filled and labeled. Carbonation in contactor 200 may be accomplished at ambient temperature. Further As used herein, ambient temperature refers to the environmental temperature where contactor 200 is located. In some embodiments, ambient temperature is from about 4° C. to about 32° C. In some embodiments, contactor 200 carbonates liquid without thermal treatment. In some embodiments, contactor 200 carbonates liquid at ambient temperature and without thermal treatment. In some embodiments, contactor 200 carbonates liquid without heating and without cooling the liquid. In some embodiments, contactor 200 carbonates liquid at a temperature of about 4° C. to about 30° C. (e.g., about 4° C. to about 20° C., about 10° C. to about 30° C., about 10° C. to about 20° C., about 15° C. to about 30° C., about 18° C. to about 28° C., or about 20° C. to about 25° C.). In some embodiments, contactor 200 carbonated liquid at a temperature of about 10° C. to about 20° C. In some embodiments, contactor 200 carbonates liquid at a temperature of about 18° C. In some embodiments, contactor 200 carbonates liquid at a temperature of about 20° C. In some embodiments, contactor 200 carbonates liquid at a temperature of about 25° C. In some embodiments, contactor 200 carbonates liquid at a temperature of about 28° C. The flexibility of carbonating at ambient temperature provides benefits to carbonation systems. For example, incoming water temperatures can vary across geographic locations and even at the same location depending on various factors, including seasonal weather. Not only does this eliminate the need for thermal treatment and related equipment, it allows for the same carbonation system and same operating conditions to be used across various locations. Example 5 illustrates carbonation at various temperatures.

After flowing through contactor 200, the liquid/gas mixture may flow through dissolution pipe 400 to allow the carbon dioxide to dissolve in the liquid. In some embodiments, pump 300 pumps the liquid/gas mixture from contactor 200 to dissolution pipe 400. Dissolution pipe 400 may be used control the residence time of the liquid/gas mixture. For example, the longer the dissolution pipe 400, the longer the residence time. In some embodiments, dissolution pipe 400 has a length of about 3 meters to about 20 meters (e.g., about 4 meters to about 7 meters, about 9 meters to about 11 meters, or about 13 meters to about 16 meters). In some embodiments, dissolution pipe 400 has a length of about 4.7 meters, about 6.5 meters, about 10.5 meters, or about 14.5 meters. As used herein, “residence time” is the amount of time the liquid spends in dissolution pipe 400 after exiting contactor 200 and before stepping down pressure for filling or dispensing. In some embodiments, the liquid/gas mixture has a residence time in dissolution pipe 400 of about 0.1 seconds to about 10 seconds (e.g., 1 second to about 9 seconds, about 2.8 seconds to about 7.8 seconds, about 2 seconds to about 4 seconds). In some embodiments, the liquid and gas mixture has a residence time of about 3 seconds. As shown in Example 6, all carbon dioxide dissolved into the liquid at residence times of 2.7 seconds or higher. Example 7 illustrates the relationship between dissolution pipe diameter and dissolution pipe length. For example, taking a standard dissolution time, a smaller pipe diameter corresponds to a longer pipe to dissolve all carbon dioxide.

Carbonator 100 may produce a carbonated liquid. Sparge 241 may be configured to provide about 1 gram to about 10 grams (e.g., about 3 grams to about 8 grams or about 5 grams to about 10 grams) carbon dioxide per liter of liquid flowing through contactor 200. In some embodiments, sparge 241 is configured to provide at least 5 grams (e.g., at least 7 grams or at least 8 grams) carbon dioxide per liter of liquid flowing through contactor 200. In some embodiments, the carbonated liquid exiting carbonator 100 may have a carbon dioxide concentration of about 1 gram to about 10 grams (e.g., about 5 grams to about 10 grams) carbon dioxide per liter of liquid flowing through contactor 200. In some embodiments, at least 5 grams (e.g., at least 7 grams or at least 8 grams) carbon dioxide per liter of liquid flowing through contactor 200. In some embodiments, the carbonated liquid has a carbon dioxide concentration of at least 5 grams per liter of liquid. In some embodiments, the carbonated liquid has a carbon dioxide concentration of at least 7 grams per liter of liquid. In some embodiments, the carbonated liquid has a carbon dioxide concentration of at least 8 grams per liter of liquid.

Carbonator 100 may produce a carbonated liquid at a rate of 1 L/min to 2000 L/min. In some embodiments, carbonator 100 produces a carbonated liquid at a rate of about 1 L/min to about 10 L/min (e.g., about 2 L/min to about 8 L/min or about 4 L/min to about 6 L/min). In some embodiments, carbonator 100 produces a carbonated liquid at a rate of about 200 L/min to about 2000 L/min (e.g., about 400 L/min to about 1000 L/min or about 500 L/min to about 750 L/min). In some embodiments, carbonator 100 produces a carbonated liquid at a rate of about 500 L/min. In some embodiments, carbonator 100 produces a carbonated liquid at a rate of about 600 L/min.

As shown throughout the Examples, systems and methods according to some embodiments may result in complete dissolution of carbon dioxide in the liquid. In contrast to existing systems, this allows for a “complete dissolution” approach when carbonating the liquid. This means controlled, exact amounts of gas may be added during carbonation to completely dissolve before moving to subsequent processing (e.g., filling, capping, labeling). In some embodiments, at least 97% of the carbon dioxide dissolves in the liquid. In some embodiments, 100% of the carbon dioxide dissolves in the liquid.

In some embodiments, all carbon dioxide has dissolved in the liquid before exiting dissolution pipe 400. This may be achieved, for example, by incorporating an appropriate ratio of liquid and carbon dioxide from liquid inlet 101 and gas inlet 111, respectively. Additionally, this may be achieved by maintaining the pressure in contactor 200 and dissolution pipe 400 at an equilibrium pressure at which the carbon dioxide will not only dissolve but remain dissolved. In some embodiments, a control system controls the flow of the carbon dioxide and the liquid such that the appropriate ratio is maintained. In some embodiments, the liquid pressure from liquid inlet 101 and the carbon dioxide pressure from gas inlet 111 are maintained at about 1 bar to about 20 bar (e.g., about 1 bar to about 5 bar) above the discharge pressure. In some embodiments, the pressure drop in the contactor 200 is about 1 bar.

In some embodiments, a control system controls the temperatures, pressures, and flow rates of various streams. In some embodiments, the control system controls the pressure and flow rate of the carbon dioxide entering contactor 200. In some embodiments, the control system controls the pressure and flow rate of the liquid entering contactor 200. In some embodiments, the control system controls monitors the mass flow rate and volumetric flow rate of fluid exiting dissolution pipe 400 to ensure these values are equal to the inlet mass flow rate and volumetric flow rate of liquid and carbon dioxide.

Carbonator 100 may be scaled up or down based desired production rate. For example, in some embodiments, carbonator 100 may include larger or smaller contactors (e.g., contactor 200). And in some embodiments, carbonator 100 may include more than one contactor (e.g., contactor 200). In some embodiments, carbonator 100 includes at least two contactors (e.g., at least three contactors). In some embodiments, carbonator 100 includes two contactors operating in parallel, as illustrated in FIG. 3B.

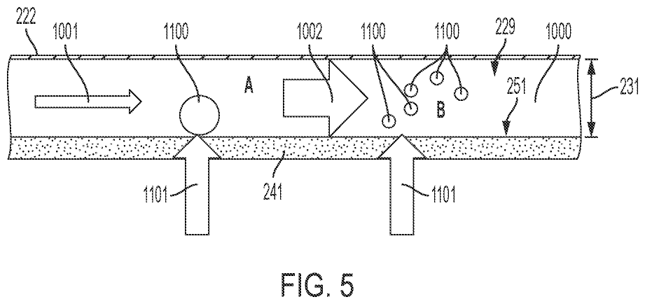

FIG. 6 illustrates a method of making a carbonated beverage according to some embodiments. In some embodiments, method 2000 includes steps 2100, 2200, and 2300. At step 2100, a liquid may be prepared. In some embodiments, the liquid is prepared at liquid source 20. In some embodiments, the liquid is an uncarbonated beverage liquid. At step 2200, the liquid may be carbonated with carbon dioxide to form a carbonated liquid. In some embodiments, the liquid may be carbonated with carbon dioxide bubbles having an average diameter less than 50 μm. At step 2300, the carbonated liquid is filled into a container (e.g., a bottle or a can).

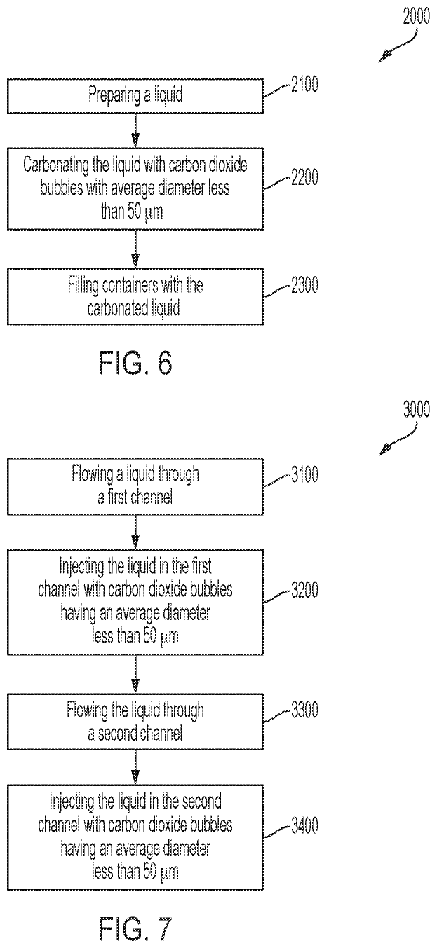

FIG. 7 illustrates a method of carbonating a beverage according to some embodiments. In some embodiments, method 3000 includes steps 3100, 3200, 3300, and 3400. At step 3100, an uncarbonated liquid may flow through a first channel (e.g., first channel 201). At step 3200, the liquid may be injected with carbon dioxide to form a liquid/gas mixture. At step 3300, the liquid/gas mixture may flow through a second channel (e.g., second channel 221). At step 3400, the liquid/gas mixture may be injected with carbon dioxide. In some embodiments, at steps 3200 and 3400, the carbon dioxide has an average diameter less than 50 μm.

Although the methods and systems described here are discussed related larger-scale beverage production and filling, it is to be understood that the systems may be used in smaller-scale applications. In some embodiments, the systems disclosed herein may be scaled down for carbonation in post-mix environment, for example for use in make-my-own beverage applications or for use in beverage dispensing machines (e.g., fountain dispensers). Smaller-scale applications may use the same technology described above. Additionally, in some embodiments, smaller scale applications like make-my-own beverages and beverage dispensing machines may pre-chill the liquid to accommodate consumer preferences for chilled beverages. Exemplary make-my-own systems are described in U.S. application Ser. No. 16/348,107, filed May 7, 2019; U.S. application Ser. No. 16/658,790, filed Oct. 21, 2019; and U.S. Appln. No. 63/310,874, filed Feb. 16, 2022. Each of these applications is incorporated herein in its entirety by reference thereto.

In contrast to existing beverage dispensing systems that use pre- and post-chill water circuits to achieve carbonation levels, embodiments disclosed herein allow for a complete dissolution approach as described above. In contrast to existing systems, which over-carbonate, complete dissolution allows for efficient carbonation at the make-my-own scale or at the beverage dispensing machine scale, with little to no loss of carbon dioxide. This in turn means fewer carbon dioxide canisters are required for the same amount of carbonation. The complete dissolution approach also improves accuracy and allows for carbonation levels to be changed quickly, which is not possible with existing systems. This enables high carbonation levels in make-my-own systems and fountains systems.

### EXAMPLES

### Example 1

One experiment evaluated carbonation at various fluid velocities. Table 2 shows the tested fluid velocity and the resulting maximum carbonation. In this experiment, the liquid was water, and the gas was carbon dioxide.

TABLE 2

| Fluid velocity (m/s) | Carbonation (g/L) |
|---|---|
| 0.67 | 8.21 |
| 0.79 | 8.77 |
| 0.95 | 8.24 |
| 1.03 | 8.61 |
| 1.27 | 8.33 |
| 1.59 | 7.80 |
| 2.91 | 10.50 |
| 3.49 | 8.44 |
| 3.88 | 7.32 |
| 4.26 | 8.67 |
| 4.72 | 9.17 |
| 7.05 | 6.06 |
| 7.52 | 8.93 |
| 7.75 | 7.67 |
| 10.52 | 7.64 |

Moreover, testing showed that all gas that flowed into the contactor was dissolved in the liquid. Accordingly, embodiments disclosed herein allow for high carbonation levels across various fluid velocities.

### Example 2

One experiment evaluated carbonation at various areal flow rates. Table 3 shows the tested areal flow rate and the resulting maximum carbonation. In this experiment, the liquid was water, and the gas was carbon dioxide.

TABLE 3

| Areal Flow Rate (L/m²/min) | Carbonation (g/L) |
|---|---|
| 3149 | 8.21 |
| 3289 | 4.40 |
| 3314 | 9.17 |
| 3330 | 8.83 |
| 3700 | 7.17 |
| 4070 | 8.67 |
| 4440 | 8.24 |
| 4810 | 8.61 |
| 4934 | 5.71 |
| 5359 | 8.93 |
| 5921 | 8.33 |
| 6578 | 7.61 |
| 6661 | 8.34 |
| 6990 | 8.44 |
| 7401 | 8.42 |
| 9868 | 5.35 |
| 14801 | 8.19 |

Moreover, testing showed that all gas that flowed into the contactor was dissolved in the liquid. Accordingly, embodiments disclosed herein allow for high carbonation levels across areal flow rates.

### Example 3

One experiment evaluated carbonation at gas pressures entering the contactor. Table 3 shows the tested gas pressure and the resulting maximum carbonation. In this experiment, the liquid was water and the gas was carbon dioxide.

TABLE 4

| Gas pressure (bar) | Carbonation (g/L) |
|---|---|
| 20 | 7.97 |
| 24 | 8.52 |
| 28 | 8.33 |
| 32 | 7.59 |
| 34 | 9.41 |

Accordingly, embodiments disclosed herein allow for high carbonation levels across various gas pressures.

### Example 4

One experiment evaluated carbonation at various total system pressures post-sparge gas pressure Table 4 shows the total system gas pressure after the sparging and the resulting maximum carbonation. In this experiment, the liquid was water and the gas was carbon dioxide.

TABLE 5

| Gas pressure (bar) | Carbonation (g/L) |
|---|---|
| 5 | 8.54 |
| 6.7 | 8.35 |
| 7.2 | 8.76 |
| 7.5 | 8.39 |
| 10 | 8.34 |
| 11 | 8.93 |
| 11.5 | 8.16 |
| 12 | 8.84 |
| 12.5 | 8.38 |
| 15 | 7.78 |

Accordingly, embodiments disclosed herein allow for high carbonation levels across various post-sparge gas pressures.

### Example 5

One experiment evaluated carbonation at various liquid temperatures flowing into the contactor. Table 5 shows the tested liquid temperatures and the resulting maximum carbonation. In this experiment, the liquid was water and the gas was carbon dioxide.

TABLE 6

| Temperature (° C.) | Carbonation (g/L) |
|---|---|
| 15 | 6.48 |
| 15.3 | 8.31 |
| 15.4 | 4.04 |
| 15.5 | 8.26 |
| 15.6 | 6.20 |
| 15.7 | 8.33 |
| 15.8 | 8.06 |
| 15.9 | 8.20 |
| 16.1 | 8.15 |
| 16.2 | 8.18 |
| 16.3 | 8.18 |
| 16.6 | 8.49 |
| 17 | 8.14 |
| 17.1 | 8.14 |
| 17.6 | 8.02 |
| 17.9 | 8.32 |
| 18 | 7.94 |
| 18.2 | 8.19 |
| 18.5 | 8.13 |
| 18.7 | 8.14 |
| 19 | 8.38 |
| 24 | 8.08 |
| 24.3 | 8.14 |
| 24.9 | 7.98 |
| 25 | 7.90 |
| 25.2 | 8.14 |
| 25.5 | 7.87 |
| 27 | 7.89 |
| 27.4 | 7.82 |
| 28.1 | 8.08 |

Moreover, testing showed that at least 97% of gas that flowed into the contactor was dissolved in the liquid. Accordingly, embodiments disclosed herein allow for high carbonation levels across various liquid temperatures.

### Example 6

One experiment evaluated carbonation at various residence times. Table 6 shows the tested residence times and the resulting maximum carbonation. In this experiment, the liquid was water and the gas was carbon dioxide.

TABLE 7

| Residence Time (s) | Carbonation (g/L) |
|---|---|
| 2.7 | 7.75 |
| 2.8 | 9.16 |
| 2.8 | 7.68 |
| 2.8 | 8.91 |
| 3.4 | 8.33 |
| 3.9 | 8.95 |
| 4.1 | 6.06 |
| 4.3 | 8.61 |
| 4.5 | 9.17 |
| 4.6 | 8.24 |
| 5.0 | 8.67 |
| 5.5 | 7.65 |
| 6.1 | 8.44 |
| 6.4 | 8.21 |
| 7.4 | 10.50 |

Moreover, testing showed that all gas that flowed into the contactor was dissolved in the liquid. Accordingly, embodiments disclosed herein allow for high carbonation levels across residence times.

### Example 7

One experiment evaluated the relationship between dissolution pipe diameter and length and time to full dissolution. the total max carbonation at various gas pressures. The results are shown in Table 7 below. The table shows various diameter and length combinations that result in a full dissolution time of 3.8 seconds.

TABLE 8

| Pipe diameter (mm) | Pipe length (m) | Time to eliminate bubbles (s) |
|---|---|---|
| 80 | 7.6 | 3.8 |
| 100 | 4.9 | 3.8 |
| 120 | 3.4 | 3.8 |

Accordingly, the dimensions of the dissolution pipe may be modified to ensure full dissolution of carbon dioxide in water.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The breadth and scope of the present disclosure should not be limited by any of the above-described exemplary embodiments, but should be defined only in accordance with the claims and their equivalents.

What is claimed is:

1. A system for carbonating a liquid, the system comprising:
a liquid source;
a carbon dioxide source; and
a contactor for carbonating the liquid, the contactor comprising:
a first channel in communication with the liquid source, the first channel having a first inner diameter, the first channel comprising a first end, a second end, and a first inlet defined in a sidewall of the first channel;
a second channel comprising a first end in fluid communication with the second end of the first channel, the second channel having a second inner diameter that is smaller than the first inner diameter; and
a sparge disposed at least partially within the first channel and at least partially within the second channel, wherein the sparge is configured to generate bubbles having an average diameter of 100 μm or less, and wherein the sparge is configured to provide carbon dioxide to the second channel at a rate of 1 gram to 10 grams carbon dioxide per liter of the liquid flowing through the contactor;
wherein the system is configured to operate at ambient temperature.

2. The system of claim 1, further comprising a restrictor disposed at the second end of the first channel, the restrictor comprising a tapered inner surface.

3. The system of claim 1, wherein the sparge comprises pores through which carbon dioxide flows.

4. The system of claim 3, wherein the pores are disposed only on the portion of the sparge disposed in the second channel.

5. The system of claim 1, wherein the sparge comprises:
a sealing end configured to seal the first end of the first channel,
a first portion of the sparge that is coaxial with the first channel,
a second portion of the sparge that is coaxial with the second channel, and
a tapered end disposed in the second channel.

6. The system of claim 1, wherein the system is configured to carbonate the liquid to 3 grams to 8 grams carbon dioxide per liter of liquid.

7. The system of claim 1, wherein system is configured to carbonate at a temperature from about 4° C. to about 32° C.

8. The system of claim 1, wherein the system is configured to carbonate 1 liter to 10 liters of the liquid per minute.

9. The system of claim 1, wherein the system is configured to carbonate 200 liters to 2000 liters per minute.

10. The system of claim 1, wherein the system is configured to carbonate the liquid without thermal treatment.

11. The system of claim 1, wherein the liquid is one of cola, a carbonated soft drink, juice, coffee, tea, water, dairy, or a protein-based liquid.

12. The system of claim 1, wherein the sparge has an outer diameter that is less than the second inner diameter such that a sparge gap is formed between the sparge and the second channel.

13. The system of claim 1, wherein the system has a height of about 2 meters, a length of about 1 meter, and a width of about 1 meter.

14. A method of carbonating a liquid, the method comprising:
flowing the liquid through a first channel of a contactor at a rate of 1 liter per minute to 2000 liters per minute;
injecting, by a sparge, carbon dioxide bubbles into the liquid, wherein the carbon dioxide bubbles have an average diameter of 100 μm or less, wherein the carbon dioxide bubbles are injected at a rate of 1 gram to 10 grams carbon dioxide per liter of the liquid,
wherein the method carbonates the liquid without thermal treatment.

15. The method of claim 14, further comprising flowing the liquid through a second channel of the contactor,
wherein the first channel has a first inner diameter and the second channel has a second inner diameter that is smaller than the first inner diameter.

16. The method of claim 15, wherein the sparge is disposed at least partially in the first channel and at least partially in the second channel.

17. The method of claim 14, wherein the rate is 500 liters per minute to 2000 liters per minute.

18. The method of claim 14, wherein the carbon dioxide is injected at a rate of 1 gram to 10 grams carbon dioxide per liter of the liquid.

19. The method of claim 14, wherein the liquid has a temperature of about 4° C. to about 32° C.

20. A system for carbonating a liquid, the system comprising:
a contactor for carbonating the liquid flowing through the contactor, the contactor comprising:
a first channel having a first inner diameter;
a second channel in fluid communication with the first channel, the second channel having a second inner diameter;
a sparge disposed at least partially within the first channel and at least partially within the second channel, the sparge configured to deliver bubbles of carbon dioxide to the liquid at a rate of at least 1 grams carbon dioxide per liter of the liquid flowing through the carbonator, the bubbles having an average diameter of 100 μm or less,
wherein the system is configured to operate at ambient temperature.

21. The system of claim 20, wherein the second inner diameter is smaller than the first inner diameter.

22. The system of claim 20, wherein the system is configured to carbonate at least 1 liter to 2000 liters of the liquid per minute.

23. The system of claim 20, wherein the sparge has an outer diameter that is less than the second inner diameter such that a sparge gap is formed between the sparge and the second channel, and wherein the sparge gap is 0.75 mm to 10 mm.

24. The system of claim 20, wherein the sparge is coaxial with the first channel and coaxial with the second channel.

25. The system of claim 24, wherein the sparge comprises a sealing end configured to seal a first end of the first channel.

26. The system of claim 20, wherein the sparge is a sintered sparge.
